(19) United States
(12) Patent Application Publication
(10) Pub. No.: US 2011/0270924 A1
(43) Pub. Date: Nov. 3, 2011

(54) Peer to Peer Network

(75) Inventors: Andreas Johnsson, Uppsala (SE); Ayodele Damola, Solna (SE)

(73) Assignee: TELEFONAKTIEBOLAGET L M ERICSSON (PUBL), Stockholm (SE)

(21) Appl. No.: 13/060,973

(22) PCT Filed: Aug. 27, 2008
(86) PCT No.: PCT/IB2008/002230

§ 371 Date: Mar. 22, 2011

(51) Int. Cl. G06F 15/16

(52) U.S. Cl. 709/204

(57) ABSTRACT

An access network (14), computer software and method for protecting an identity of a user (12) connected via the access network (14) to a peer to peer network (22), from other users (12) of the peer to peer network (14). The method includes receiving at the access network (14) a request from the user (12) for using the peer to peer network (22), the request including at least a first identity (IP) of the user (12) and data related to content stored or desired by the user (12), associating the first identity (IP) of the user (12) with a second identity (IPₚ₂ₚ), different from the first identity (IP), where a relationship between the second identity (IPₚ₂ₚ) and the first identity (IP) of the user (12) is generated by the access network (14), and transmitting the second identity (IPₚ₂ₚ) instead of the first identity (IP) to the peer to peer network (22) together with the data related to content from the request, such that the first identity (IP) of the user (12) is not provided to the peer to peer network (22).

### TECHNICAL FIELD

The present invention generally relates to devices, software and methods and, more particularly, to mechanisms and techniques for preserving the privacy of a user when accessing a peer to peer (P2P) network.

### BACKGROUND

During the past years, the users of various media content (e.g., music, video, text, etc.) are increasingly networking together for sharing the media content. One such example was Napster. This web based application, allowed the users to be the provider of content and also the consumers of the content. In effect, the users were exchanging files including media content with other users. This decentralized network allowed the users to receive the desired files faster than from commercial media content providers, which act as a central point of connection for multiple users.

Thus, a P2P network simplifies the media exchange among various users by offering the users, among others, the possibility to directly connect to each other. The P2P computer network uses diverse connectivity between participants in a network and the cumulative bandwidth of network participants rather than conventional centralized resources where a relatively low number of servers provide the core value to a service or application. P2P networks are typically used for connecting nodes via largely ad hoc connections. Such networks are useful for many purposes. Sharing content files containing audio, video, data or anything in digital format is very common, and real-time data, such as telephony traffic, may also be passed using P2P technology.

A pure P2P network does not have the notion of clients or servers but only equal peer nodes that simultaneously function as both “clients” and “servers” to the other nodes on the network. This model of network arrangement differs from the client-server model where communication is usually to and from a central server. A typical example of a file transfer that is not P2P is a file transport protocol (FTP) server where the client and server programs are quite distinct, the clients initiate the download/uploads, and the servers react to and satisfy these requests.

Early P2P networks included the Usenet news server system, in which peers communicated with one another to propagate Usenet news articles over the entire Usenet network. The same consideration applies to the Simple Mail Transfer Protocol (SMTP) email in the sense that the core email relaying network of Mail transfer agents is a P2P network while the periphery of Mail user agents and their direct connections is client server.

When downloading content using P2P clients, pieces of the selected file may be gathered from several nodes simultaneously in order to decrease download time and to increase robustness of the P2P network. A view of such a download activity using BitTorrent (201 Mission Street, San Francisco, Calif. 94105) is shown in FIG. 1. FIG. 1 shows in the upper right part the download progress (file names and percentages of files already downloaded) while the bottom part of the figure shows the IP addresses of the clients that act as the providers of the content being downloaded. However, disclosing the IP addresses of the users is undesirable for the users as the users would like to maintain their privacy.

PPLive (see this system at www.pplive.com) is an example of a P2P system that is used for distributing TV content among a group of users. In this application, the IP addresses of the participating peers are not revealed as in the BitTorrent application discussed with regard to FIG. 1. However, the IP addresses of the users can easily be gathered using network sniffing software, such as tcpdump, which is a common packet sniffer that allows the user to intercept and display the transmission control protocol (TCP/IP) and other packets being transmitted or received over a network to which the computer is attached.

Thus, as the P2P technology becomes more widely used among software vendors, security related matters from using this technology appear. One such matter is privacy concerns as shown above with an application such as Bittorrent or PPLive, where the IP addresses of all content sources are or may be revealed to the content receiver. The implication of the lack of privacy is that the identity of a provider may be discovered and also the type of content a peer possesses may be discovered. The IP address of that peer user may then be traced to a particular user or household and this is highly undesirable from a user privacy and integrity point of view.

Based on recent trends, like those with BBC's IP player (see BBC iPlayer uptake statistics: http://beyondnessofthings.wordpress.com/2007/08/03/bbc-iplayer-first-publicly-released-uptake-stats/), it is believed that the P2P technology will be used by content providers in the near future as a cheap way to distribute media content. Thus, at some point in future, the network operators themselves may turn to using P2P for content distribution, in particular video distribution. However, the end users, either private persons or companies, would need to be assured that their privacy is protected.

One attempt to protect the privacy of the users was made by Darknet or private P2P networks. Darknet and private P2P networks use a concept in the P2P domain where the users are anonymous in the system. A Darknet is a private virtual network where users connect only to people they trust. In its most general meaning, a darknet can be any type of closed, private group of people communicating among themselves, but the name is most often used specifically for file sharing networks.

Private P2P networks are peer-to-peer networks that only allow some mutually trusted computers to share files. This can be achieved by using a central server or hub to authenticate the computers or their users, in which case the functionality is similar to a private FTP server, but with files transferred directly between the clients. Alternatively, the users can exchange passwords or keys with their friends to form a decentralized network. Private P2P networks can be classified as friend-to-friend (F2F) or group-based. Friend-to-friend networks only allow connections between users who know one another. Group-based networks allow any user to connect to any other, and thus they cannot grow in size without compromising their users' privacy. Some software, such as WASTE (see http://wasteagain.sourceforge.net/), can be configured to create either group-based or F2F networks. Freenet is another example (see FreeNet website: http://freenetprojectorg/) of private P2P networks.

However, common problems with the private P2P networks have been identified as being that (i) a node in a private P2P network requires more effort to set up and maintain, because all peers have to be connected manually; this is especially problematic if a user wishes to try out several different private P2P applications, and (ii) often, not enough direct friends are motivated to run the application continuously.

In addition, the private P2P networks are not simple to use for the technically un-savvy end user in the case where the private P2P network is used to distribute video in at mass scale.

Accordingly, it would be desirable to provide devices, systems and methods that avoid the afore-described problems and drawbacks.

### SUMMARY

According to one exemplary embodiment, there is a method for protecting an identity of a user connected via an access network to a peer to peer network, from other users of the peer to peer network. The method includes receiving at the access network a request from the user for using the peer to peer network, the request including at least a first identity of the user and data related to content stored or desired by the user, associating the first identity of the user with a second identity, different from the first identity, where a relationship between the second identity and the first identity of the user is generated by the access network, and transmitting the second identity instead of the first identity to the peer to peer network together with the data related to content from the request, such that the first identity of the user is not provided to the peer to peer network.

According to another exemplary embodiment, there is an access network for protecting an identity of a user connected via the access network to a peer to peer network, from other users of the peer to peer network. The access network includes an input/output unit configured to receive a request from the user for using the peer to peer network, the request including at least a first identity of the user and data related to content stored or desired by the user; a network address translator connected to the input/output unit and configured to associate the first identity of the user with a second identity, different from the first identity, where a relationship between the second identity and the first identity of the user is generated by the access network; and a processor connected to the network address translator and the input/output unit and configured to transmit the second identity instead of the first identity to the peer to peer network together with the data related to content from the request, such that the first identity of the user is not provided to the peer to peer network.

According to still another exemplary embodiment, there is a computer readable medium including computer executable instructions, where the instructions, when executed by a processor of an access network, cause the processor to protect an identity of a user connected via an access network to a peer to peer network, from other users of the peer to peer network. The instructions include receiving at the access network a request from the user for using the peer to peer network, the request including at least a first identity of the user and data related to content stored or desired by the user; associating the first identity of the user with a second identity, different from the first identity, wherein a relationship between the second identity and the first identity of the user is generated by the access network; and transmitting the second identity instead of the first identity to the peer to peer network together with the data related to content from the request, such that the first identity of the user is not provided to the peer to peer network.

According to still another exemplary embodiment, there is a method for protecting an identity of a user connected to a peer to peer network, from other users of the peer to peer network. The method includes receiving at the peer to peer network a request from the user for using the peer to peer network, the request including at least a first identity of the user and data related to content stored or desired by the user; associating the first identity of the user with a second identity, different from the first identity, where a relationship between the second identity and the first identity of the user is generated by the peer to peer network; and using the second identity instead of the first identity of the user in the peer to peer network together with data related to content from the request, such that the first identity of the user is not known by other users of the peer to peer network.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is an actual view of an interface of a peer to peer network;

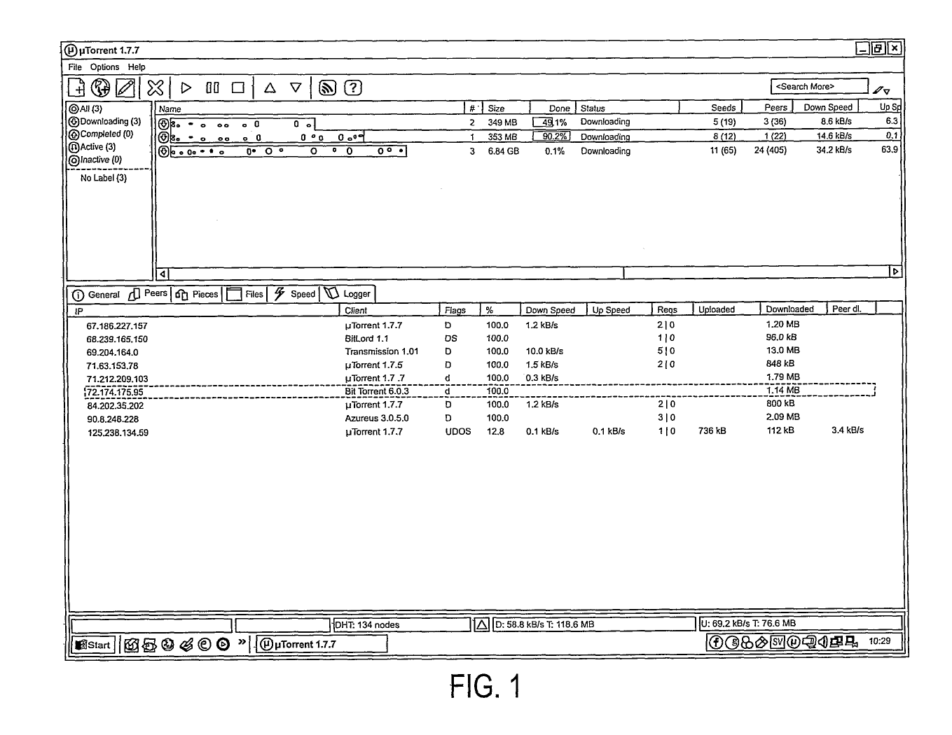

FIG. 2 is a schematic diagram of a network that includes an access network with a network address translator according to an exemplary embodiment;

FIG. 3 is a schematic diagram of a part of an access network that includes a management module according to an exemplary embodiment;

FIG. 4 is a schematic diagram illustrating various interactions between clients, access networks, and a peer to peer network according to an exemplary embodiment;

FIG. 5 is flow chart illustrating steps performed in an access network for protecting an identity of a user according to an exemplary embodiment;

FIG. 6 is a schematic diagram of a network that includes an access network according to an exemplary embodiment;

FIG. 7 is a flow chart illustrating steps performed in a peer to peer network for protecting an identity of a user according to an exemplary embodiment; and

FIG. 8 is a schematic diagram of an access network according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of P2P networks described above. However, the embodiments to be discussed next are not limited to these networks but may be applied to other existing systems and networks.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

The problems identified in the Background section in the existing P2P networks may be solved, according to an exemplary embodiment, by hiding the identity of a specific user who would like to share/receive content via the P2P network and presenting an operator allocated identity to the P2P network instead of the user's real identity. In another embodiment, the P2P network hides the real identity of the user and provides a newly allocated identity. Also, the embodiments to be discussed next present solutions to the privacy problem of the user such that the user is not required to be a computer expert, and allow the user to securely use large P2P networks and not only private P2P networks. Also, the solutions presented in the following embodiments may be implemented not only in the user's computer but also in other devices via which the user may connect to the P2P networks, for example, set top box, TV, mobile phone, etc. Various embodiments that are discussed next achieve one or more of these advantages by hiding the real identity of the peer via, for example, a network address translator (NAT), see RFC 1631, The IP Network Address Translator at http://www.faqs.org/rfcskfc1631.html, the entire content of which is incorporated here by reference.

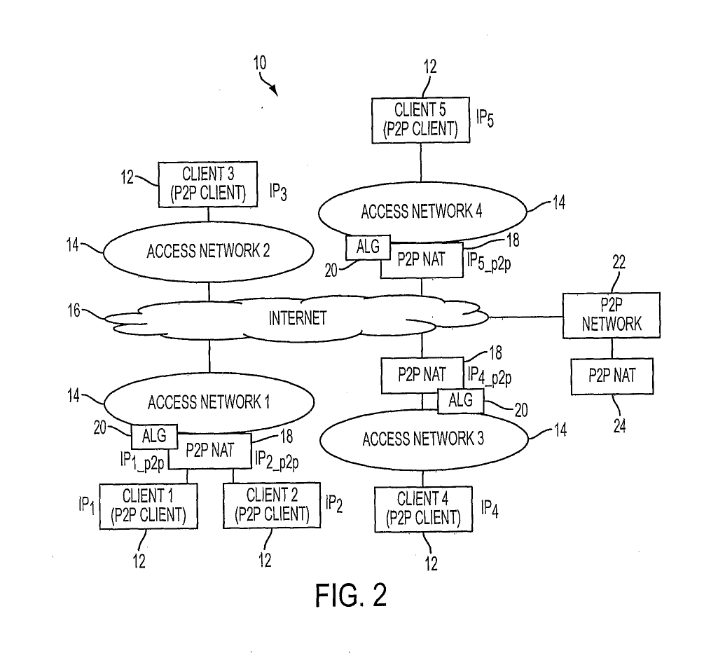

As shown in FIG. 2, according to an exemplary embodiment, a P2P network includes plural clients 12 connected via various access networks 14 to internet 16. The clients 12 may be, for example, a mobile phone, a computer, a set top box, or other devices that are capable of exchanging information with the internet. The access networks 14 may be, for example, a communication network, a phone network, an internet service provider (ISP), etc. The access networks 14 may include a unit 18 that provides the NAT function for the P2P network. According to another exemplary embodiment, the NAT functionality may be implemented by using an application layer gateway 20, as will be discussed later. The NAT functionality may be implemented in software on a corresponding piece of hardware.

According to an exemplary embodiment, each client 12 may register with this functionality in the P2P-NAT 18 of the local ISP 14, before entering a P2P content delivery network (CDN) 22. As shown in FIG. 2, the P2P-NAT functionality 18 may be placed at different locations in the corresponding operator network 14, for example, at an access-network edge (see access network 1) at the first aggregation point, or at other points (see access network 3) of the access network. One advantage of having the P2P-NAT functionality at the first point of aggregation is to allow for privacy between users within the same access network. In other words, Clients 1 and 2 shown in FIG. 2 would have assigned P2P_IP addresses when communicating with each other via the access network 1. Thus, each of these clients would not be visible to each other.

In another exemplary embodiment, the P2P-NAT functionality is not provided in the access network 14 but rather in the P2P network, for example, in the BitTorrent location on the Internet. FIG. 2 shows this optional location of the P2P-NAT functionality in which the P2P network 22 is connected to internet 16 but is outside the access networks 14 and the P2P NAT functionality 24 is located within or next to the P2P network 22. It is also noted that the P2P functionalities 18 and 24 (which may be identical) may be provided simultaneously in the system 10.

The registration of the user 12 within the access network 14 may be performed in order to create a NAT binding between the client IP address (first identity) and a new public IP address (second identity), which is to be used within the P2P network. The new IP address is called a P2P_IP address. For example, there may be a binding between the real address IP₁ of Client 1 and IP₁_{_{—}}ₚ₂ₚ address assigned by the P2P NAT 18, as shown in FIG. 2.

In other words, according to this exemplary embodiment, the client 12 obtains a new IP address (P2P_IP) from the P2P-NAT 18 and this new IP address is used within the P2P network. Thus, even if the P2P_IP address of the client is known in the P2P network, other parties cannot track or identify the real identity of the client behind the P2P_IP address because this P2P_IP address is not the real identity of the client. Further, the P2P NAT 18 unit may be configured such that an unauthorized party may not receive information regarding the real IP address of the client that corresponds to the P2P_IP address. In other words, the relationship between the real IP address and the assigned P2P_IP address is maintained confidential in the P2P NAT unit.

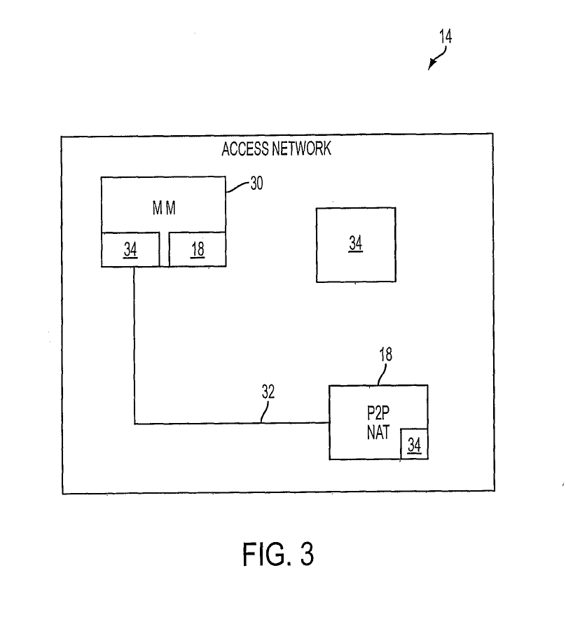

In one exemplary embodiment, the P2P NAT assigns the P2P_IP address to each client that is registered with the access network in which the P2P NAT unit resides. In another exemplary embodiment, the assignment of the P2P_IP address to a client is performed in a management module (MM) 30 of the access network 14, as shown in FIG. 3. The P2P NAT module 18 may be informed by the access network 14 about the correspondence between the real IP address of the client and the assigned P2P_IP address. The correspondence of these IP addresses may be stored in a table in a storage unit 34, either in the P2P NAT module 18 or at a location in the corresponding access network 14 as shown for example in FIG. 3. FIG. 3 shows that the storage unit 34 may be located in various places of the access network 14. FIG. 3 also shows that the management module 30 may be configured to communicate with the P2P NAT module 18 via a communication link 32.

In one exemplary embodiment, also shown in FIG. 2, there are no requirements on implementing the P2P-NAT functionality at all locations of the network, see for example that access network 2 does not have the P2P-NAT functionality and thus, Client 3 uses the real IP address when connecting to the P2P network. The P2P-NAT functionality may be implemented as an add-on feature for a given access network or P2P network operator. In addition, in another exemplary embodiment, the operator having the P2P-NAT functionality may provide this feature to selected clients, as an optional service to its customers.

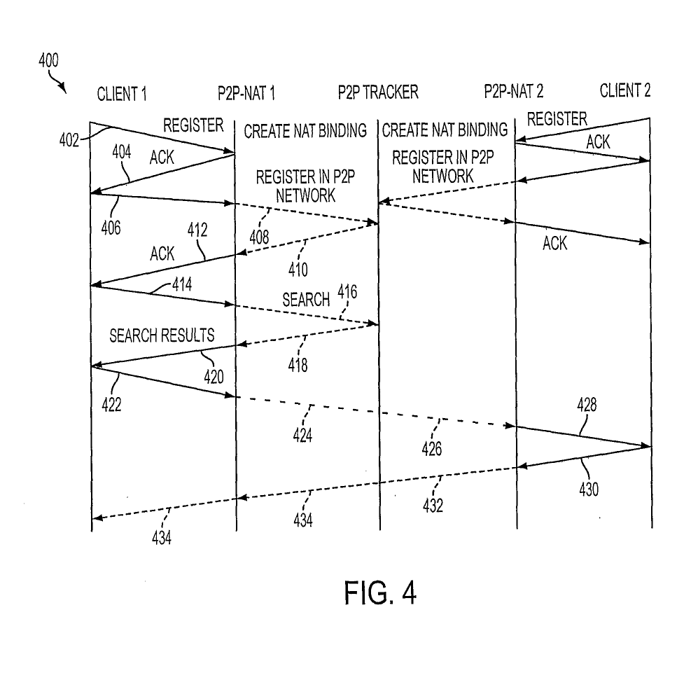

Next, a method for providing the P2P-NAT functionality, that is present into an access network, to a client and steps associated with this functionality are discussed with regard to FIG. 4. In step 400, the client 1 registers with the local operator that has the P2P-NAT functionality to receive this functionality. The registration step may be implemented in many ways, two of which are discussed next. The registration may be performed via a signaling protocol or using an application layer gateway (ALG), based on deep packet inspection. Deep packet inspection is a form of computer network packet filtering that examines the data and/or header part of a packet as it passes an inspection point, searching for non-protocol compliance, viruses, spam, intrusions or predefined criteria to decide if the packet can pass or if it needs to be routed to a different destination, or for the purpose of collecting statistical information. This is in contrast to shallow packet inspection (usually called just packet inspection), which just checks the header portion of a packet.

If the signal protocol is used, the client's software may be modified (via an update for example) to request a P2P IP address from the P2P NAT functionality. Upon receiving the request in step 400 from the client, the P2P NAT module associates in step 402 a P2P_IP address (for example a routable IP address) and creates a NAT binding tying the public (real) IP address of the P2P client to this new P2P_IP address. All subsequent traffic from the client to the P2P network through the access network is NAT-ed at the P2P-NAT module. Thus, the visible IP address of the P2P client becomes the P2P_IP address for the P2P network.

In step 404, the client may receive an acknowledgment from the P2P-NAT module informing the client that he is able to safely use the P2P application by transmitting or requesting data in future steps. If the client desires to exchange data with the P2P network, the client may register with the P2P network. For example, the client sends in step 406 a request to register with a P2P tracker. A P2P tracker may be any P2P searching mechanism (e.g., the BitTorrent tracker system). If one of the clients does not use the P2P-NAT, then the P2P tracker uses the real IP address of that client. The request of step 406 is transmitted via the P2P-NAT module to the P2P tracker in step 408. It is noted that the real IP address of the client is not used in step 408. In steps 410 and 412, the P2P tracker sends a response to the client via the access network. It is noted that all the steps between the P2P-NAT module and the P2P network (represented by dash lines in FIG. 4) do not show the real IP address of the client, thus protecting his or her privacy. In steps 414 and 416, a search request may be sent by the client to the P2P tracker for searching the desired content of the P2P network. Data related to the content stored or desired by the client may be included in step 414 and the second identity (new identity) and the data related to the content may be included in step 416.

In response for the specific content request from the client, the P2P tracker may respond, in steps 418 and 420, to the client with a source (IP address of client 2) for the requested content. Then, client 1 may send the content request to client 2 in steps 422, 424, 426 and 428 and client 2 may reply with the desired content to client 1 in steps 430, 432, 434, and 436.

In the ALG case, there is no explicit request of the client for a P2P_IP address. The ALG, when based on deep packet inspection, may detect that a P2P application is started and may automatically create a NAT binding, i.e., association of P2P_IP address to the client as discussed in a previous example. One advantage of this method is that the P2P application does not have to be modified with a signaling protocol to request the NAT binding to be created at the P2P NAT unit 18. One disadvantage of this method is that the method may not work if the P2P application encrypts its traffic and the deep packet inspection cannot detect the traffic of all P2P applications. However, this disadvantage may be remedied if the deep packet inspection is functionality modified to be capable to decrypt the traffic related to the P2P application. The ALG functionality may be implemented in the access networks, for example, in Ericsson's Mobile Internet Enabling Proxy.

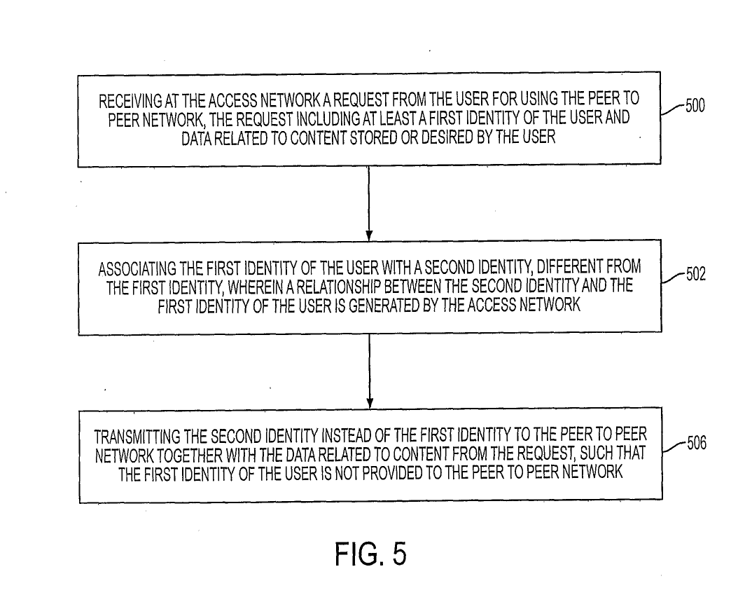

Steps to be performed by the access network for protecting an identity of a user connected via the access network to a peer to peer network, from other users of the peer to peer network, are discussed next with regard to FIG. 5. In this regard, FIG. 5 shows a step 500 of receiving at the access network a request from the user for using the peer to peer network, the request including at least a first identity of the user and data related to content stored or desired by the user, a step 502 of associating the first identity of the user with a second identity, different from the first identity, where a relationship between the second identity and the first identity of the user is generated by the access network, and a step 506 of transmitting the second identity instead of the first identity to the peer to peer network together with the data related to content from the request, such that the first identity of the user is not provided to the peer to peer network.

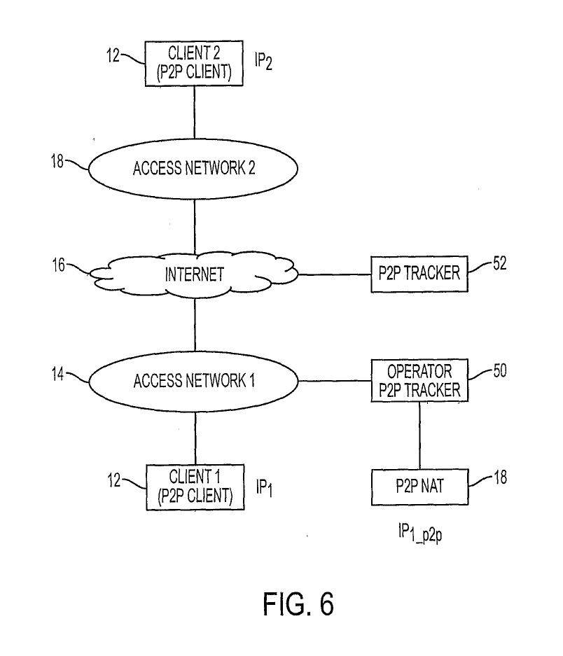

According to another exemplary embodiment, a P2P tracker/searching node/facility 50 may be introduced in the access network as shown for example in FIG. 6. One advantage of this arrangement is that no changes are needed to the P2P client. Client 1 now registers with the local Operator P2P Tracker 50, instead of the P2P tracker 52 located on the Internet. The Operator P2P Tracker 50 may provide part or all the functionality provided by the tracker P2P 52 of the P2P network and extra functionality to the clients as described next.

According to this embodiment, a client may register as a seed in the Operator P2P Tracker 50 describing the content it has stored. The Operator P2P Tracker may request the P2P_IP address (new identity) for the client from the P2P-NAT module 18. The P2P-NAT module 18 may create a NAT binding of the real IP₁ of the client such that an IP₁_{_{—}}ₚ₂ₚ is provided. The P2P-NAT 18 returns the IP₁_{_{—}}ₚ₂ₚ to the Operator P2P Tracker 50. Client 1 may be registered, at the operator tracker, with the new IP address corresponding to the P2P_IP address. If client 2 performs a P2P search and finds out that client 1 has the desired content, the IP₁_{_{—}}ₚ₂ₚ shows up as the content holder. A request may be made by client 2 to this address and the content may be fetched through the P2P-NAT module. This way, the real IP address of client 1 is hidden to others, thus providing the desired privacy to client 1.

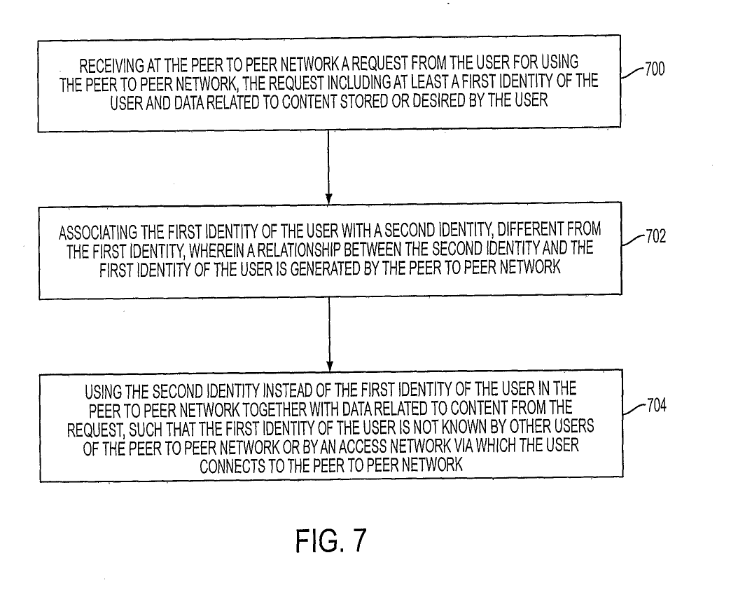

According to this exemplary embodiment, steps to be performed by the peer to peer network for protecting an identity of a user connected to the peer to peer network, from other users of the peer to peer network, are discussed with regard to FIG. 7. In this regard, FIG. 7 shows a step 700 of receiving at the peer to peer network a request from the user for using the peer to peer network, the request including at least a first identity of the user and data related to content stored or desired by the user, a step 702 of associating the first identity of the user with a second identity, different from the first identity, where a relationship between the second identity and the first identity of the user is generated by the peer to peer network, and a step 704 of using the second identity instead of the first identity of the user in the peer to peer network together with data related to content from the request, such that the first identity of the user is not known by other users of the peer to peer network or by an access network via which the user connects to the peer to peer network.

One or more advantages of one or more exemplary embodiments discussed above are related to the privacy of the clients, the scalability of the system, and the backward compatibility of the system. Regarding the privacy, the exemplary embodiments disclose techniques for not revealing what content a specific client has by hiding the real identity of the client. Thus, it is not possible to monitor what a client is watching (assuming a P2P TV application) or has stored (P2P Voice on Demand (VoD)). Regarding the backward compatibility, there is no such issue with the peers not using the operator's P2P privacy mechanism as these peers are able to still connect to the P2P network as before.

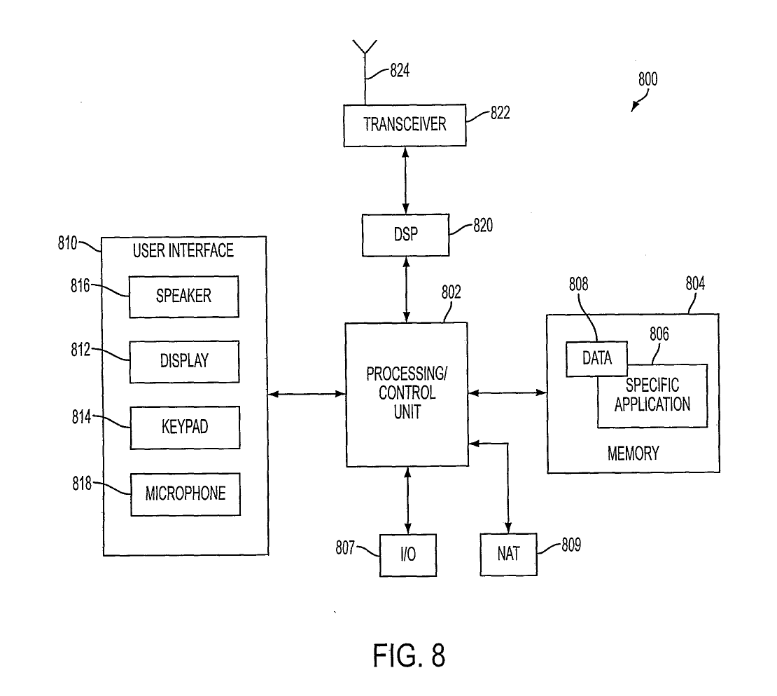

For purposes of illustration and not of limitation, an example of a representative access network that includes a P2P-NAT module capable of carrying out operations in accordance with the exemplary embodiments is illustrated in FIG. 8. It should be recognized, however, that the principles of the present exemplary embodiments are equally applicable to standard access networks.

The exemplary access network arrangement 800 may include a processing/control unit 802, such as a microprocessor, reduced instruction set computer (RISC), or other central processing module. The processing unit 802 need not be a single device, and may include one or more processors. For example, the processing unit 802 may include a master processor and associated slave processors coupled to communicate with the master processor.

The processing unit 802 may control the basic functions of the access network as dictated by programs available in the storage/memory 804. Thus, the processing unit 802 may execute the functions described in FIGS. 2 and 6. More particularly, the storage/memory 804 may include an operating system and program modules for carrying out functions and applications on the access network. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the access network arrangement 800 via data signals, such as being downloaded electronically via a network, such as the Internet.

One of the programs that may be stored in the storage/memory 804 is a specific program 806 that provides the P2P NAT functionality. As previously described, the specific program 806 may interact with a client for hiding its true identity. The program 806 and associated features may be implemented in software and/or firmware operable by way of the processor 802. The program storage/memory 804 may also be used to store data 808, such as the various relationships between the real identities of the clients and the corresponding new identities, or other data associated with the present exemplary embodiments. In one exemplary embodiment, the programs 806 and data 808 are stored in non-volatile electrically-erasable, programmable ROM (EEPROM), flash ROM, etc. so that the information is not lost upon power down of the access network 800.

The processor 802 may also be coupled to an input/output unit 807 and a network access translation unit 808 as shown in FIG. 8. The input/output unit 807 may be configured to receive requests from the users and the network access translation unit 808 may be configured to implement the NAT functionality. The processor 802 may be also coupled to user interface 810 elements associated with the access network. The user interface 810 of the access network may include, for example, a display 812 such as a liquid crystal display, a keypad 814, speaker 816, and a microphone 818. These and other user interface components are coupled to the processor 802 as is known in the art. The keypad 814 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism.

The access network arrangement 800 may also include a digital signal processor (DSP) 820. The DSP 820 may perform a variety of functions, including analog-to-digital (ND) conversion, digital-to-analog (D/A) conversion, speech coding/decoding, encryption/decryption, error detection and correction, bit stream translation, filtering, etc. The transceiver 822, generally coupled to an antenna 824, may transmit and receive the radio signals associated with a wireless device. However, the transceiver 822 may be wired coupled to the Internet.

The access network arrangement 800 of FIG. 8 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 806 and associated features, and data 808, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems.

The disclosed exemplary embodiments provide an access network, a method and a computer program product for hiding a true identity of a client from a network by substituting a new identity to the true identity of the client. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

What is claimed is:

1. A method for protecting an identity (IP) of a user (12) connected via an access network (14) to a peer to peer network (22), from other users (12) of the peer to peer network (22), the method comprising:
receiving at the access network (14) a request from the user (12) for using the peer to peer network (22), the request including at least a first identity of the user (IP) and data related to content stored or desired by the user (12);
associating the first identity (IP) of the user (12) with a second identity (IPₚ₂ₚ), different from the first identity (IP), wherein a relationship between the second identity (IPₚ₂ₚ) and the first identity (IP) of the user is generated by the access network (14); and
transmitting the second identity (IPₚ₂ₚ) instead of the first identity (IP) to the peer to peer network (22) together with the data related to content from the request, such that the first identity (IP) of the user (12) is not provided to the peer to peer network (22).

2. The method of claim 1, further comprising:
maintaining the relationship between the second identity and the first identity of the user within the access network such that the relationship is not shared with the peer to peer network or other users.

3. The method of claim 1, further comprising:
applying the second identity to all traffic originating from the user having the first identity and being directed to the peer to peer network.

4. The method of claim 1, wherein the first and second identities are Internet Protocol (IP) addresses or port numbers, the first identity being the real address of the user.

5. The method of claim 1, wherein the access network is configured such that other users of the peer to peer network that use the access network do not see the first identity of the user.

6. The method of claim 1, wherein the transmitting comprises:
substituting in the request the first identity of the user with the second identity.

7. The method of claim 1, further comprising:
searching, by a tracker in the access network, the peer to peer network for specified content requested by the user.

8. The method of claim 7, wherein the tracker receives the request from the user and the tracker requires the second identity from a network address translator placed in the access network.

9. The method of claim 1, wherein the second identity is generated by a network address translator placed in the access network.

10. The method of claim 9, wherein the network address translator is implemented as a module or as an application layer gateway.

11. An access network (14) for protecting an identity of a user (12) connected via the access network (14) to a peer to peer network (22), from other users (12) of the peer to peer network (22), the access network (14) comprising:
an input/output unit (807) configured to receive a request from the user (12) for using the peer to peer network (22), the request including at least a first identity (IP) of the user and data related to content stored or desired by the user (12);
a network address translator (18, 809) connected to the input/output unit (807) and configured to associate the first identity (IP) of the user (12) with a second identity (IPₚ₂ₚ), different from the first identity (IP), wherein a relationship between the second identity (IPₚ₂ₚ) and the first identity (IP) of the user (12) is generated by the network address translator (18, 809); and
a processor (802) connected to the network address translator (18, 809) and the input/output unit (807) and configured to transmit the second identity (IPₚ₂ₚ) instead of the first identity (IP) to the peer to peer network (22) together with the data related to content from the request, such that the first identity (IP) of the user (12) is not provided to the peer to peer network (22).

12. The access network of claim 11, wherein the processor is configured to maintain the relationship between the second identity and the first identity of the user within the access network such that the relationship is not shared with the peer to peer network and other users.

13. The access network of claim 11, wherein the network address translator is further configured to apply the second identity to all traffic originating from the user having the first identity and being directed to the peer to peer network.

14. The access network of claim 11, wherein the first and second identities are Internet Protocol (IP) addresses, the first identity being the real address of the user.

15. The access network of claim 11, wherein the network address translator is implemented in the processor.

16. The access network of claim 11, wherein the processor is configured to substitute in the request the first identity of the user with the second identity.

17. The access network of claim 11, further comprising:
a tracker module configured to search the peer to peer network for specified content requested by the user.

18. The access network of claim 17, wherein the tracker module receives the request from the user and the tracker module requires the second identity from a network address translator placed in the access network.

19. The access network of claim 11, wherein the network address translator is implemented as an independent module or as an application layer gateway.

20. A computer readable medium including computer executable instructions, wherein the instructions, when executed by a processor (802) of an access network (14), cause the processor (802) to protect an identity of a user (12) connected via the access network (14) to a peer to peer network (22), from other users (12) of the peer to peer network (22), the instructions comprising:
receiving at the access network (14) a request from the user (12) for using the peer to peer network (22), the request including at least a first identity (IP) of the user (12) and data related to content stored or desired by the user (12);
associating the first identity (IP) of the user with a second identity (IPₚ₂ₚ), different from the first identity (IP), wherein a relationship between the second identity (IPₚ₂ₚ) and the first identity (IP) of the user (12) is generated by the access network (14); and
transmitting the second identity (IPₚ₂ₚ) instead of the first identity (12) to the peer to peer network (22) together with the data related to content from the request, such that the first identity (IP) of the user (12) is not provided to the peer to peer network (22).

21. A method for protecting an identity of a user (12) connected to a peer to peer network (22), from other users (12) of the peer to peer network (22), the method comprising:
receiving at the peer to peer network (22) a request from the user (12) for using the peer to peer network (22), the request including at least a first identity (IP) of the user (12) and data related to content stored or desired by the user (12);
associating the first identity (IP) of the user (12) with a second identity (IPₚ₂ₚ), different from the first identity (IP), wherein a relationship between the second identity (IPₚ₂ₚ) and the first identity (IP) of the user (12) is generated by the peer to peer network (22); and
using the second identity (IPₚ₂ₚ) instead of the first identity (IP) of the user (12) in the peer to peer network (22) together with data related to content from the request, such that the first identity (IP) of the user (12) is not known by other users (12) of the peer to peer network (22).

22. The method of claim 21, further comprising:
maintaining the relationship between the second identity and the first identity of the user within the peer to peer network such that the relationship is not shared with the other users and the access network.

23. The method of claim 21, wherein the first and second identities are Internet Protocol (IP) addresses or port numbers, the first identity being the real address of the user.

24. The method of claim 21, wherein the using comprises:
substituting in the request the first identity of the user with the second identity.

25. The method of claim 21, wherein the second identity is generated by a network address translator placed in the peer to peer network.

26. The method of claim 25, wherein the network address translator is implemented as an independent module or as an application layer gateway.
